(19) United States
(12) Patent Application Publication
(10) Pub. No.: US 2026/0170181 A1
(43) Pub. Date: Jun. 18, 2026

(54) MULTI-DIE RING OSCILLATOR WITH SPLIT ENTROPY FOR SECURITY AND PHYSICAL UNCLONABLE FUNCTION (PUF) APPLICATIONS

(71) Applicant: XILINX, INC., San Jose, CA (US)

(72) Inventors: Aswani Aditya Kumar TADINADA, Hyderabad (IN); Venkatasuryam Setty ISSA, Hyderabad (IN); Chiragkumar Mansukhbhai SENJALIYA, Hyderabad (IN); Shadi BARAKAT, Redwood City, CA (US); Thomas Paul LEBOEUF, Sandia Park, NM (US); James ANDERSON, Madison, AL (US); James D. Wesselkamper, Albuquerque, NM (US)

(21) Appl. No.: 18/981,128

(22) Filed: Dec. 13, 2024

(51) Int. Cl. G06F 21/73; G06F 21/72; H04L 9/32

(52) U.S. Cl. CPC G06F 21/73; G06F 21/72; H04L 9/3278; H04L 2209/12

(57) ABSTRACT

A multi-die ring oscillator with split entropy for security and physical unclonable function (PUF) applications includes a PUF circuit that includes a current source circuit that sources currents from a gated supply voltage and controls the currents based on an analog voltage, a voltage controller (e.g., a differential-input OTA) that controls the analog voltage based on first and second ones of the currents, and a ring oscillator that outputs a clock based on a third one of the currents, where a frequency of the clock is based on the third current and random variations of components of the PUF circuit. The voltage controller and the ring oscillator may be placed on a first die, and the current source circuit may be placed on a second die. The PUF circuit may be configurable to alter the clock frequency and/or to provide the clock with time-multiplexed frequencies.

### TECHNICAL FIELD

Examples of the present disclosure generally relate to multi-die ring oscillators with split entropy for security and physical unclonable function (PUF) applications.

### BACKGROUND

A physical unclonable function (PUF) circuit generates a signature (e.g., a sequence of bits) that is unique to the PUF circuit, based on random variations of components of the PUF circuit. The random variations serve as sources of entropy that are unique to the PUF circuit. The random variations may be independent and uncorrelated across devices and/or within a device. Examples random variations include, without limitation, dopant fluctuation, line-edge roughness, and random telegraph noise. The random variations may impact transistor voltage thresholds/gate delays, voltage drops, and/or other parameters. Random variations may be more pronounced at smaller process scales, where variations become a larger percentage of lengths/widths of devices. PUF circuits are used in security applications, such as authentication of devices in which the PUF circuits are embedded.

### SUMMARY

Multi-die ring oscillators with split entropy for security and physical unclonable function (PUF) applications are described. One example is an integrated circuit device that includes a physical unclonable function (PUF) circuit distributed over multiple dies of the integrated circuit device, where the PUF circuit includes a current source circuit that sources first, second, and third currents from a gated supply voltage, and controls the first, second, and third currents based on an analog voltage. The PUF circuit further includes a voltage control circuit that controls the analog voltage based on the first and second currents, and a ring oscillator circuit that outputs a clock having a frequency that is based on the third current and random variations of components of the PUF circuit.

Another example is an integrated circuit device that includes a first die having a voltage control circuit that controls an analog voltage based on first and second currents, and a ring oscillator circuit that generates a clock based on a third current. The integrated circuit device further includes a second die having a current source circuit that sources the first and second currents and a third current from a gated supply voltage, and controls the first, second, and third currents based on the analog voltage. The integrated circuit device further includes a signature generator circuit that determines a bit value based on a frequency of the clock, and constructs a signature of the integrated circuit device based on the bit value.

Another example described herein is method that includes providing a gated supply voltage from a first die of an integrated circuit device to a second die of the integrated circuit device, sourcing first, second, and third currents from the gated supply voltage and controlling the first, second, and third currents based on an analog voltage, by a current source circuit of the second die. The method further includes controlling the analog voltage based on the first and second currents, by a voltage control circuit of the first die, and generating a clock based on the third current, by a ring oscillator circuit of the first die.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 depicts an integrated circuit (IC) device that includes a physical unclonable function (PUF) circuit, according to an embodiment.

FIG. 2 depicts the IC device of FIG. 1, according to an embodiment.

FIG. 3 depicts the IC device of FIG. 1, according to an embodiment.

FIG. 4 depicts a voltage control circuit of the PUF circuit, according to an embodiment.

FIG. 5 depicts the IC device of FIG. 1, according to an embodiment.

FIG. 6 depicts the IC device of FIG. 1 with multiple PUF circuits and a signature generator circuit, according to an embodiment.

FIG. 7 depicts a ring oscillator circuit of the PUF circuit, according to an embodiment.

FIG. 8 depicts the IC device of FIG. 1, according to an embodiment.

FIG. 9 depicts the IC device of FIG. 1, according to an embodiment.

FIG. 10 depicts the IC device of FIG. 1, according to an embodiment.

FIG. 11 depicts a method of generating a clock having a frequency that is based in part on random variations of a PUF circuit, according to an embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe multi-die ring oscillators with split entropy for security and physical unclonable function (PUF) applications.

A PUF system may include multiple pairs of ring oscillators that generate respective clocks. Frequencies of the clocks may vary amongst the ring oscillators due to random process variations (i.e., mismatches in ring oscillator delay stages). The ring oscillators may be operated for a period of time (e.g., at start-up), and the clocks may be provided to respective counters over the period of time. A difference in counter values for a pair of the ring oscillators is a function of a difference in the clock frequencies of the respective ring oscillators. The difference in the counter values may be used to generate a corresponding static entropy true random number (TRN). The TRN, and TRNs generated from other pairs of ring oscillators may be combined to form a multi-bit signature that is unique to the PUF system.

A challenge with ring oscillator-based PUF systems is that, when a supply voltage (i.e., VDD) is distributed to the ring oscillators over a power mesh, a supply gradient (differing voltage/IR drops across the power mesh) imparts a deterministic systematic mismatch between the ring oscillators. The deterministic systematic mismatch may alter the frequency of oscillators systematically, such that the frequency differences between pairs of the ring oscillators do not depend solely on random mismatches. Instead, the frequency differences are also a function of a deterministic quantity. As a result, bit values determined from the frequency differences are not TRNs.

Another challenge with ring oscillator-based PUF systems is that the clocks of the ring oscillators may suffer from injection locking through the power mesh and/or through substrate couplings.

Another challenge with ring oscillator-based PUF systems is susceptibility to malicious intrusion (e.g., de-layering) and monitoring (e.g., electro-magnetic radiation monitoring to detect clock frequencies).

A multi-die ring oscillator-based PUF system, as disclosed herein, includes one or more PUF circuits that are splintered/distributed amongst multiple dies (e.g., a 3-dimensional die stack and/or a 2.5-dimension arrangement). Splintering/distributing a PUF system amongst multiple dies may be useful to incorporate additional sources of entropy and/or to enhance security (e.g., if any one of the dies is stack is tampered with, the clock frequency will be altered and/or the PUF circuit will be rendered non-functional/inoperable). Sources of entropy may be separated into groups and distributed amongst intra-die and/or inter-die, such that that a signature generated by the PUF system is a function of entropy sources of the multiple groups. Splintering/distributing the PUF system may be useful to prevent an attacker from generating the signature from any one of the dies.

Ring oscillators of the one or more PUF circuits may be isolated from a supply voltage/power mesh to mitigate impacts of variations in the supply voltage and corresponding systematic gradient in clock frequencies, and/or to reduce/minimize injection locking/frequency pulling via the power mesh. In an example, the ring oscillators are biased with supply voltage independent current sources, such that variations in the supply voltage and corresponding systematic gradient in clock frequencies are mitigated/attenuated by power supply rejection (PSRs) of the current sources. In this example, frequency differences amongst clocks of the PUF circuits are solely or predominantly a function of mismatches amongst the bias currents applied to the ring oscillators, which are functions of transistor and resistor random mismatches. The ring oscillators in this example may be referred to as current-controlled oscillators (CCOs). The supply voltage independent current sources may improve DC and AC PSR, and/or may reduce demands/complexity of power grid layout. The supply voltage independent current sources may also serve as additional sources of entropy (e.g., due to mismatches of transistors and/or resistors of the current sources). The supply voltage independent current sources may include supply voltage independent Vth/R current sources with temperature compensation. Ring oscillators of multiple PUF circuits may be physically spaced apart from one another to reduce/minimize injection locking via inter-die or intra-die connections (e.g., via a wiring substrate, an interposer, or a package substrate).

A PUF circuit, as disclosed herein, may be configurable to alter the clock frequency. A control circuit may dynamically re-configure the PUF circuit to provide the clock with multiple time-multiplexed (TM) frequencies. Where a signature generator circuit determines a TRN based on a clock generated by pairs of PUF circuits, such as described further above, TM frequencies may be useful to obfuscate the frequencies used by the signature generator. In another example, a signature generator circuit determines a TRN based on two or more TM frequencies of a single clock. In another example, and a signature generator circuit determines one or more unique signatures based on TM frequencies of a single clock.

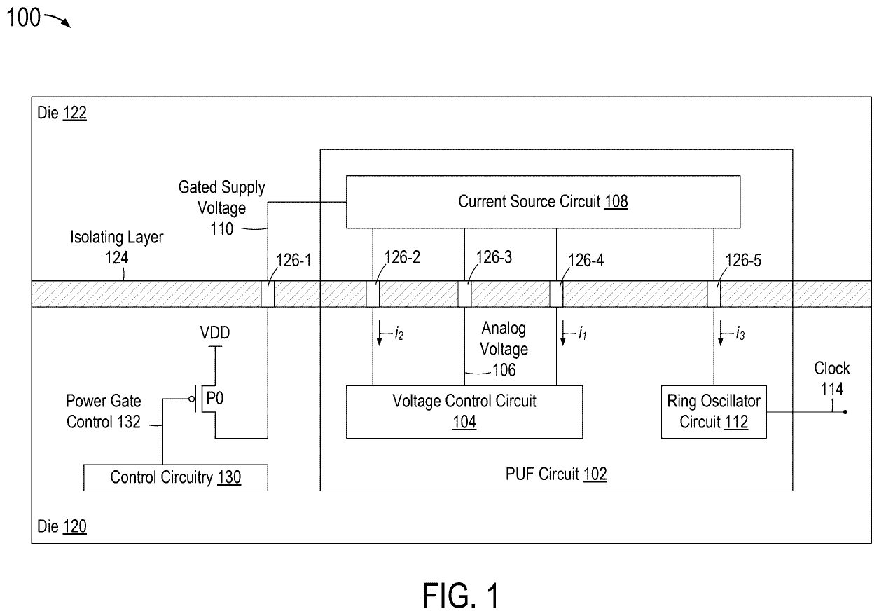

FIG. 1 depicts an integrated circuit (IC) device 100 that includes a physical unclonable function (PUF) circuit 102, according to an embodiment. In the example of FIG. 1, PUF circuit 102 includes a ring oscillator circuit 112 that generates a clock 114 having a frequency that is based on a current i3 and entropy/random variations of components of ring oscillator circuit 112 (e.g., transistors and/or resistors). PUF circuit 102 may also be referred to as a clock generator circuit.

PUF circuit 102 further includes a voltage-controlled current source circuit 108 that controls current i3, and currents i1 and i2 based on an analog voltage 106. Current source circuit 108 permits ring oscillator to operate based on a supply-independent bias, which may be useful to reduce/minimize impacts of IR drop of a power mesh of a supply voltage VDD and/or to reduce/minimize injection locking via the power mesh. IC device 100 may further include a power gate circuit, depicted here as a P-type transistor P0, that provides a gated supply voltage 110 to current source circuit 108. IC device 100 may further include control circuitry 130 that activates (e.g., pulls-down) a power gate control 132 to enable transistor P1 to provide gated supply voltage 110 to current source circuit 108.

PUF circuit 102 further includes a voltage control circuit 104 that controls analog voltage 106 based on currents i1 and i2. Voltage control circuit 104 may include a differential amplifier, examples of which are provided further below. Voltage control circuit 104 and current source circuit 108 provide additional sources of entropy that impact analog voltage 106 and currents i1, i2, and i3, and thus impact the frequency of clock 114 (i.e., contribute to the randomness/uniqueness of TRU generated from clock 114).

PUF circuit 102 may be splintered/distributed throughout IC device 100. In the example of FIG. 1, PUF circuit 102 is splintered/distributed amongst dies 120 and 122. Splintering/distributing PUF circuit 102 amongst multiple dies may enhance security in that, if either of dies 120 and 122 is tampered with (e.g., de-layered), operation of PUF circuit 102 will be disabled or disrupted (e.g., entropy generation functionality of PUF circuit 102 may be altered). Splintering/distributing PUF circuit 102 amongst multiple dies may also be useful to incorporate entropy of multiple dies into the frequency of clock 114, which may enhance the uniqueness of a signature generated from clock 114. Splintering/distributing PUF circuit 102 amongst multiple dies may also useful to provide clocks for the respective dies.

Sources of entropy of PUF circuit 102 may be distributed substantially evenly amongst multiple dies. In the example of FIG. 1, ring oscillator circuit 112 and voltage control circuit 104 (and the corresponding entropies/randomness) are placed in die 120, and current source circuit 108 is placed in a second die 122. Ring oscillator circuit 112 and voltage control circuit 104 may represent approximately fifty percent of the total entropy of PUF circuit 102, and current source circuit 108 represent the remaining entropy (e.g., approximately fifty percent) of the entropy of PUF circuit 102. PUF circuit 102 is not limited to the foregoing examples. In other examples, one or more sources of entropy are placed in one or more additional dies. Components of PUF circuit 102 may be also be distributed/dispersed throughout respective dies 120 and 122.

In FIG. 1, dies 120 and 122 are depicted in a stacked or 3-dimensional (3D) configuration. Die 120 may represent a lower-most die of IC device 100, and die 122 may represent an upper-most die of IC device 100. In other examples, IC device 100 may include one or more additional dies below die 120, above die 122, and/or between dies 120 and 122.

In FIG. 1, dies 120 and 122 are separated by an electrically isolating layer 124 (e.g., a dielectric such as silicon dioxide). Isolating layer 124 may include metal-filled vias 126-1 through 126-5 that provide electrical connections between dies 120 and 122. Layer 124 may include a substrate of die 122, and vias 126 may include through-silicon vias (TSVs). IC device 100 is not limited to a stacked or 3D configuration. In another example, dies 120 and 122 may arranged in a horizontal plane, interconnected via a wiring substrate, an interposer, and/or a package substrate.

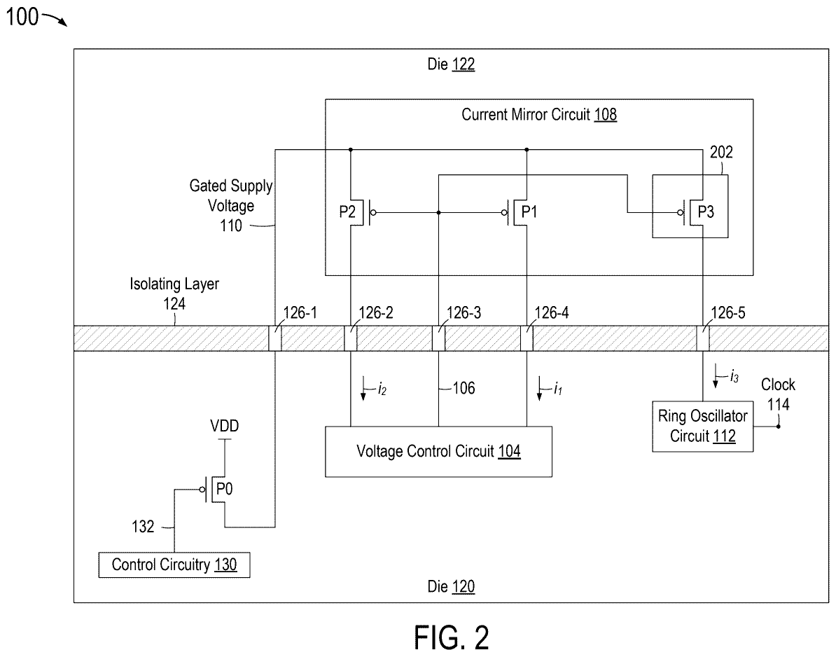

FIG. 2 depicts IC device 100, according to an embodiment. In the example of FIG. 2, current source circuit 108 includes P-type transistors P1, P2, and P3 that control respective currents i1, i2, and i3 based on analog voltage 106. Transistors P1, P2, and P3 may be arranged as current mirrors, such that currents i1, i2, and i3 are substantially equal to one another, or scaled versions of one another, subject to variations due to random differences in voltage thresholds. In an example, transistor P3 is part of a ring oscillator current source circuit 202 that includes multiple selectable transistors (e.g., a bank of selectable transistors) to vary current i3, such as described further below.

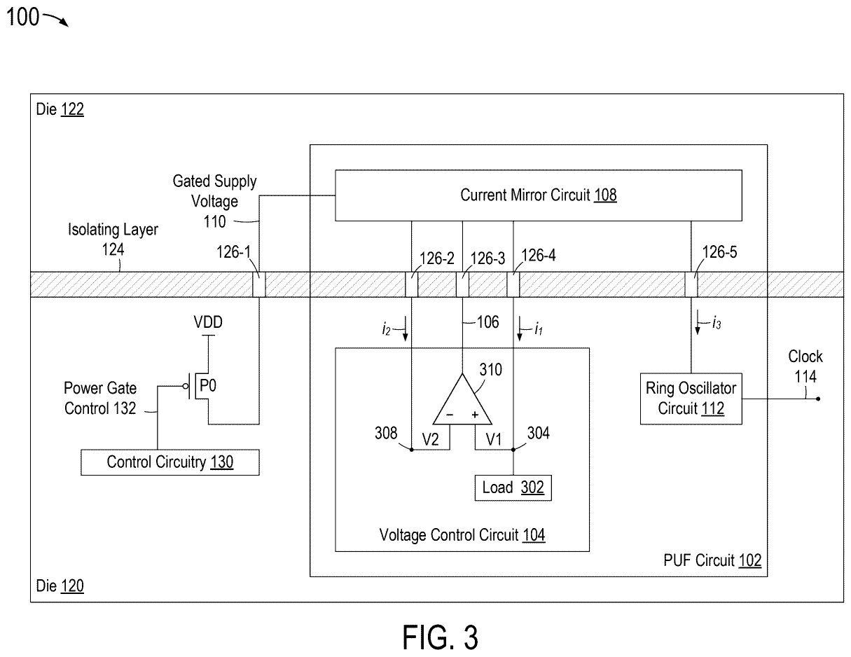

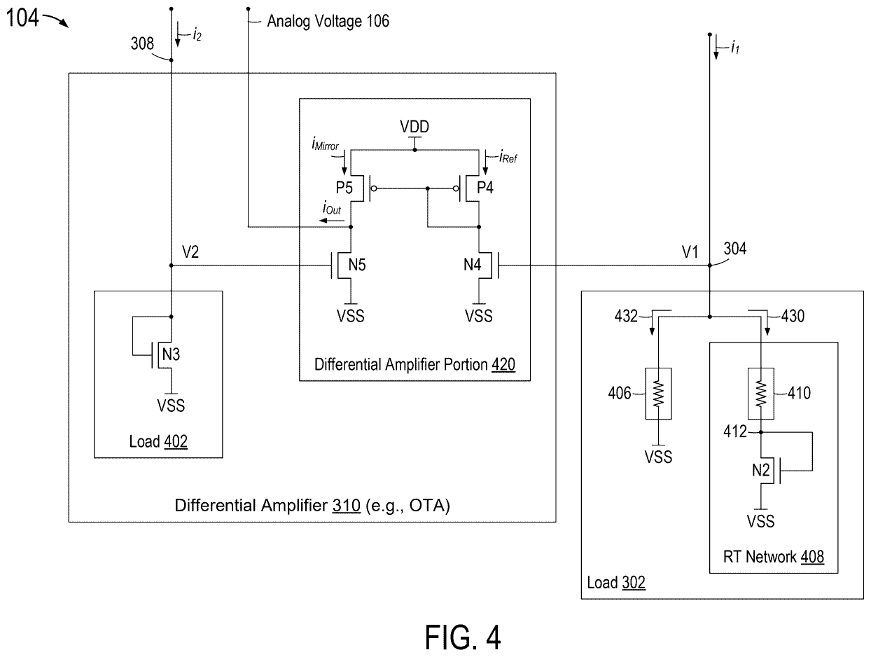

FIG. 3 depicts IC device 100, according to an embodiment. In the example of FIG. 3, voltage control circuit 104 includes a load 302 that establishes a voltage V1 at a node 304 based on current i1. Voltage control circuit 104 further includes a differential amplifier circuit 310 that controls analog voltage 106 to reduce a difference between voltage V1 and a voltage V2 at a node 308 (e.g., to maintain voltage V2 substantially equal to voltage V1). Differential amplifier circuit 310 may include a differential operational transconductance amplifier (OTA), such as described below with reference to FIG. 4. An OTA converts an input voltage (e.g., voltage V1) to an output current, where the output current is proportional to the input voltage. An OTA may serve as a voltage controlled current source (VCCS). An OTA may be configured to amplify or integrate either voltages or currents.

FIG. 4 depicts voltage control circuit 104, according to an embodiment. In the example of FIG. 4, load 302 includes a resistor circuit 406 in parallel with a resistive/transistor (RT) network 408. RT network 408 includes a resistor circuit 410 in series with a diode-connected transistor N2 (i.e., source and drains of transistor N2 are shorted).

Further in FIG. 4, differential amplifier circuit 310 is depicted as a single-stage differential OTA that includes a load 402 and a differential amplifier portion 420. Differential amplifier portion 420 includes differential input transistors N4 and N5 having gates controlled by voltages V1 and V2, respectively, and transistors P4 and P5 arranged as a current mirror. Differential amplifier portion 420 may operate similar to a 5-transistor differential amplifier, without a tail current source (i.e., a tail-less OTA). A tail-less OTA may be useful in low voltage applications, where device stacking is limited due to IR drop (i.e., voltage drop).

Load 402 includes a diode-connected transistor N3. When the width/length (W/L) ratio of transistor N3 is relatively large, V2 is approximated to the threshold voltage (Vth) of transistor N3, and voltage V1 at node 304 is the same as voltage V2 at node 308 based on virtual ground effect. In this situation, the current across resistor 406 can be given by, ICTAT=Vth/R, where R represents the resistance of resistor circuit 406, and its CTAT (decreasing with temperature-as Vth decreasing with temperature) in nature. For RT network 408, current across resistor circuit 410 is given by, IPTAT=(V1−Vgs2)/R (410) and its PTAT (increasing with temperature) in nature. The total current, i1=ICTAT+IPTAT; hence current i1 is less sensitive to temperature because current across branches 430 and 432 compensate one another with respect to temperature changes.

A PUF circuit, as disclosed herein, may be configurable to alter the frequency of clock 114, such as described below. Altering the frequency of clock 114 may be useful for test/verification purposes, to enhance security, and/or to provide clock 114 with time-division multiplexed frequencies (i.e., frequency hopping).

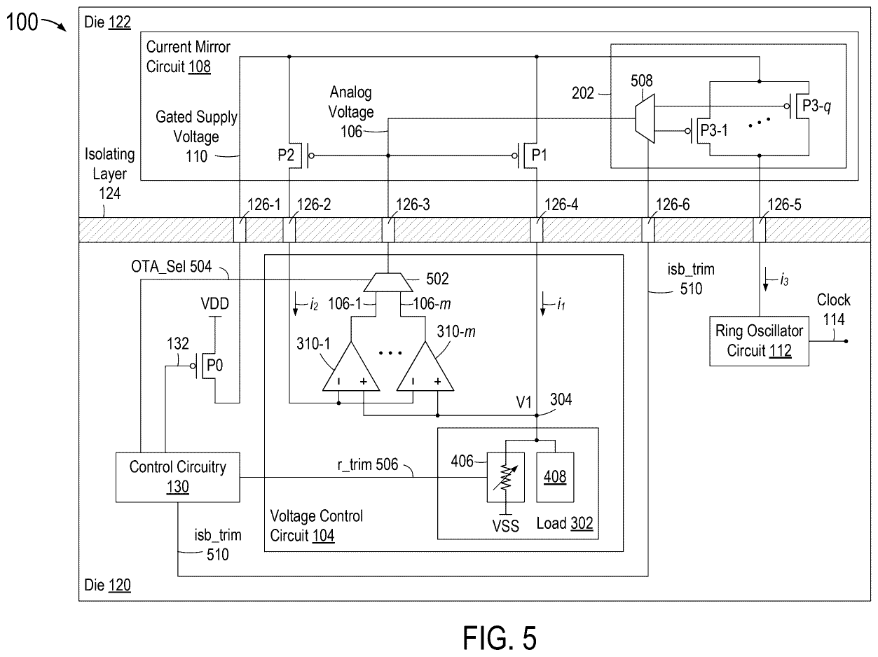

FIG. 5 depicts IC device 100, according to an embodiment. In the example of FIG. 5, voltage control circuit 104 includes multiple differential amplifier circuits 310-1 through 310-m (e.g., OTAs) that control respective analog voltages 106-1 through 106-m, based on the currents i1 and i2. Differential amplifier circuits 310-1 through 310-m may include respective loads 306 that provide respective voltages V2, such as depicted in FIG., 4. Voltage control circuit 104 further includes selector circuitry, depicted here as a multiplexer 502, that provides a selectable one of analog voltages 106-1 through 106-m to second die 122 based on an OTA_Sel control 504 from control circuitry 130. Analog voltages 106-1 through 106-m may differ from one another due to random variations of circuit elements of the respective differential amplifier circuits 310-1 through 310-m. Selectable analog voltages 106-1 through 106-m may be useful for altering the frequency of clock 114.

Further in FIG. 5, resistor circuit 406 is depicted as a variable resistance that is controlled with on a r_trim control 506 from control circuitry 130. When the resistance is altered, voltage V1 changes. When voltage V1 changes, a selected one of differential amplifier circuits 310-1 through 310-m adjusts the respective analog voltage 106 based on a difference between voltage V1 and the corresponding voltage V2, and current source circuit 108 adjusts currents i1, i2, and i3 based on the adjustment to analog voltage 106, until the voltage V2 matches voltage V1. Altering current i3 alters the frequency of clock 114. Resistor circuit 404 may include a bank of selectable resistors, and r_trim control 506 may include a multi-bit control word to select or enable one or more of the resistors. Selectable resistors may be useful for altering the frequency of clock 114, and may provide additional sources of entropy from die 120.

Further in FIG. 5, ring oscillator current source circuit 202 is depicted as a configurable current source that includes a bank of transistors P1-1 through P1-q. Ring oscillator current source circuit 202 may further include selection circuitry 508 that provides analog voltage 106 to selected ones of transistors P1-1 through P1-q based on an isb_trim control 510 (e.g., a multi-bit control word) from control circuitry 130. In FIG. 5, isb_trim control 510 is provided from control circuitry 130 through a metal-filled via 126-6 (e.g., a TSV). Control circuitry 130 may alter r_trim control 506 to alter current i3, and thus alter the frequency of clock 114. Transistors P1-1 through P1-q may also serve as additional source of entropy from die 122.

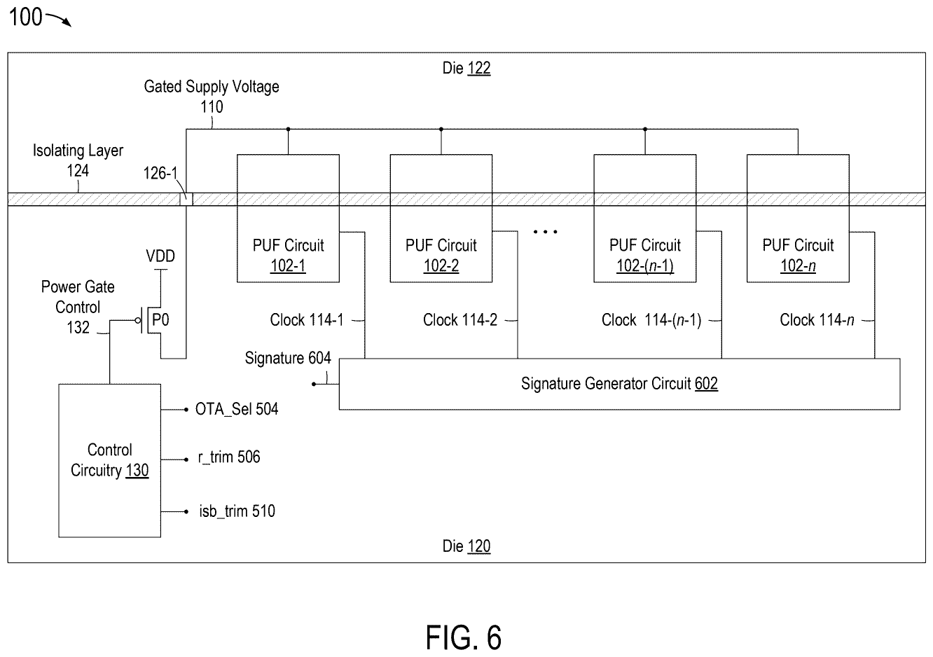

A PUF circuit, as disclosed herein, may be useful for generating a signature (e.g., a digital signature) that is unique to IC device 100, examples of which are provided below. FIG. 6 depicts IC device 100 with multiple PUF circuits 102-1 through 102-n, and a signature generator circuit 602, according to an embodiment. PUF circuits 102-1 through 102-n generate respective clocks 114-1 through 114-n. PUF circuits 102-1 through 102-n may be designed or configured to generate clocks 114-1 through 114-n with identical frequencies but, due to random process variations, frequencies of clocks 114-1 through 114-n may differ from one another, in a random fashion depending on random variations of circuit elements (e.g., transistors and/or resistors) of the PUF circuits.

In an example, signature generator circuit 602 compares pairs of clocks 114-1 through 114-n to one another, and generates a TRN (e.g., a logic one or a logic zero) for each pair depending upon which clock is faster. As an example, if the frequency of clock 114-1 is faster than the frequency of clock 114-2, signature generator circuit 602 may generate a TRN of one. In an example, n=512, and signature generator circuit 602 generates a 256-bit signature 604 that is unique to IC device 100. IC device 100 is not limited to 256-bit signatures or binary values. In another example, signature generator circuit 602 generates signature 604 based on a logical and/or mathematical function of the frequency difference between pairs of clocks 114-1 through 114-n. In another example, signature generator circuit 602 generates signature 604 as a 512-bit (or other numbers of bits) signature from n=512 by changing the configurable resistor/capacitor/other circuit elements.

In another example, control circuitry 130 dynamically reconfigures PUF circuits 102-1 through 102-n (i.e., using OTA_Sel control 504, r_trim control 506, and/or isb_trim control 510), to provide clocks 114-1 through 114-n with multiple time-multiplexed (TM) frequencies. In this example, signature generator circuit 602 may determine a TRN for each clock 114-1 through 114-n (i.e., one TRM per PUF circuit) based on the TM frequencies of the respective clocks. Alternatively, signature generator circuit 602 may determine multiple TRNs based on TM frequencies of a single clock 114 of a single PUF circuit 102, and may construct signature 604 based on the multiple TRNs of the single clock.

Signature 604 may be useful to authenticate IC device 100 and/or to authenticate a device that includes IC device 100 (e.g., a computer, smart phone, a banking terminal, an automotive or aircraft controller, an Internet-of-Things (IoT) device, and/or other device). Signature generator circuit 602 may provide signature 604 to a signature authentication system for authentication of IC device 100. The signature authentication system may be external of the integrated circuit device (e.g., within a host device and/or a network-connected device), and signature generator circuit 602 may provide signature 604 to the authentication system via a secure channel. Alternatively, the signature authentication system may be implemented within IC device 100 (e.g., a platform management controller and/or a trusted execution unit).

Control circuitry 130 may dynamically reconfigure PUF circuits 102-1 through 102-n for other purposes, such as to obfuscate frequencies used by signature generator circuit 602. In an example, control circuitry 130 dynamically reconfigures PUF circuits 102-1 through 102-n to provide clocks 114-1 through 114-n with multiple time-division multiplexed frequencies, and signature generator circuit 602 uses a subset of one or more of the time-division multiplexed frequencies of each clock to generate signature 604. In the event an attacker determines the frequencies of clocks 114-1 through 114-n (e.g., by monitoring electro-magnetic radiation of IC device 100), the attacker will not know which of the frequencies signature generator circuit 602 uses to generate signature 604. The subsets may be selectable via control circuitry 130 or signature generator circuit 602. Control circuitry 130 may use pre-determined settings to generate the un-used frequencies, or may use random settings.

In another example, control circuitry 130 dynamically reconfigures PUF circuits 102-1 through 102-n to characterize PUF circuits 102-1 through 102-n. (e.g., for verification and/or yield testing).

Control circuitry 130 may be configurable/programmable to perform one or more functions described herein.

In the example of FIG. 6, IC device 100 includes a single power gate circuit (i.e., transistor P0) that provides gated supply voltage 110 to all PUF circuits 102. In another example, IC device 100 includes multiple power gate circuits that provide gated supply voltages to respective ones of PUF circuits 102.

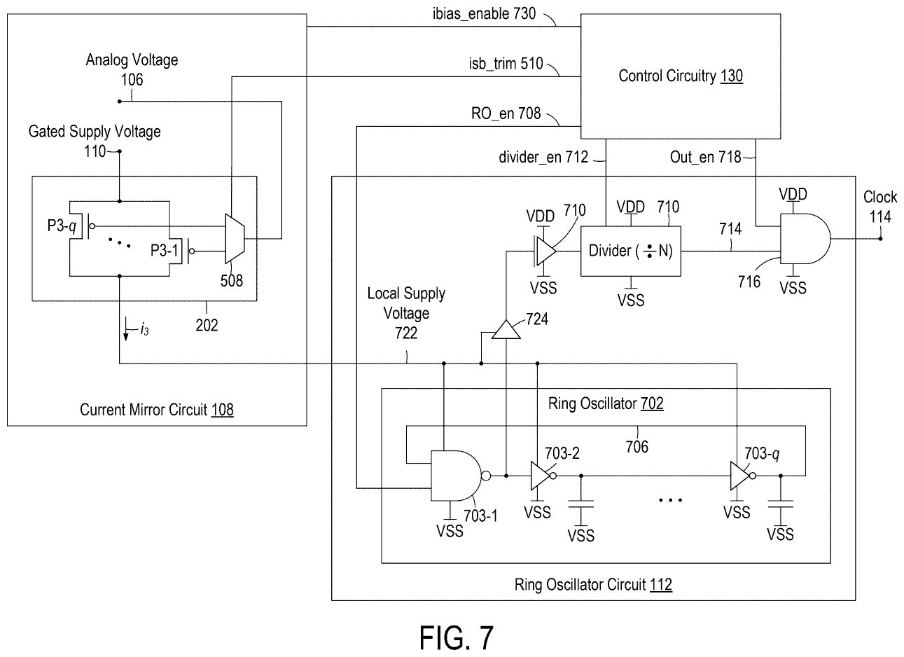

In FIG. 1, ring oscillator circuit 112 may be implemented in a variety of embodiments. FIG. 7 depicts ring oscillator circuit 112, according to an embodiment. Ring oscillator circuit 112 is not, however, limited to the example of FIG. 7. In the example of FIG. 7, ring oscillator circuit 112 includes ring oscillator 702 that includes an odd number of inverting delay stages 703-1 through 703-q (collectively, inverting delay stages 703) that provide periodically alternating states in a feedback loop 706. A frequency of the periodically alternating states depends on gate delays of transistors of inverting delay stages 704, which may vary due to random fabrication-induced variations. In FIG. 7, inverting delay stage 704-1 is depicted as a NAND gate that also serves to enable and disable ring oscillator 702 based on a ring oscillator enable control, RO_en 708. Control circuitry 130 may generate RO_en 708 based on an ibias_enable control 730 that enables current mirror circuit 108. Inverting delay stages 704 may include single-ended delay stages and/or differential delay stages.

Ring oscillator circuit 112 may further include a frequency divider circuit 710 that selectively divides the frequency of feedback loop 706 based on a divider_en control 712 (e.g., from control circuitry 130). Frequency divider circuit 710 outputs a periodic signal 714. A frequency of periodic signal 714 may be equal to the frequency of feedback loop 706 when frequency divider circuit 710 is disabled. The frequency of periodic signal 714 may be a fraction of the frequency of feedback loop 706 when frequency divider circuit 710 is enabled.

Ring oscillator circuit 112 may further include output control circuitry, depicted here as an AND gate 716, that outputs periodic signal 714 as clock 114 when an Out_en control 718 is pulled up (e.g., by control circuitry 130).

Ring oscillator circuit 112 may further include local supply voltage circuitry 720 (e.g., a power gate P6) that provides a local supply voltage 722 to ring oscillator 702 and an isolation buffer 724 based on current i3 from current source circuit 108 and isb_trim 510. In this example, frequency divider circuit 710 and AND gate 716 may be connected to global supply (VDD/VSS), and ring oscillator circuit 112 may further include a level shift circuit 726, powered by VDD/VSS, that level-shifts an output of isolation buffer 724 from a voltage swing of local supply voltage 722/VSS to a voltage swing VDD/VSS.

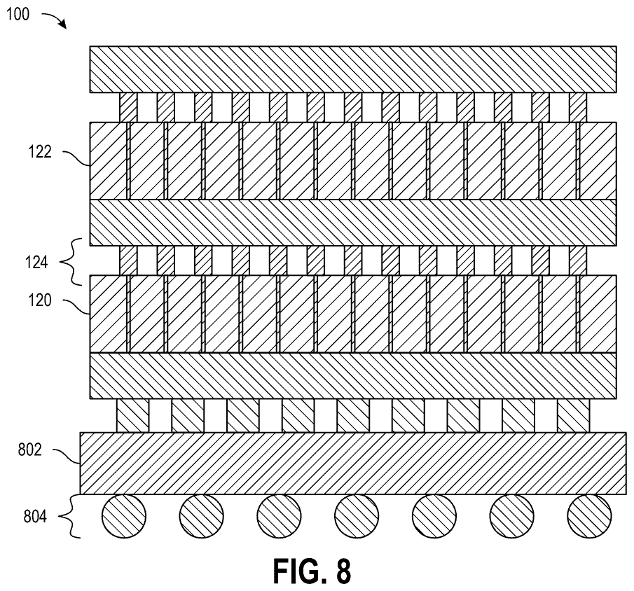

IC device 100 may be implemented in a variety of configurations, examples of which are provided below. FIG. 8 depicts IC device 100, according to an embodiment. In the example of FIG. 8, die 120 is mounted on a package substrate 802. Package substrate 802 may include external pads 804 (e.g., solder bumps) and internal interconnects (e.g., through-silicon-vias, a wiring substrate, and/or an interposer) to provide electrical interconnections between die 120 and one or more external devices (e.g., via an external printed circuit board, wiring substrate, and/or interposer). The example of FIG. 8 may be referred to as a 3-dimensional (3D) IC device. In FIG. 8, IC device 100 may include one or more additional dies, above die 122, below die 120, and/or between dies 120 and 122.

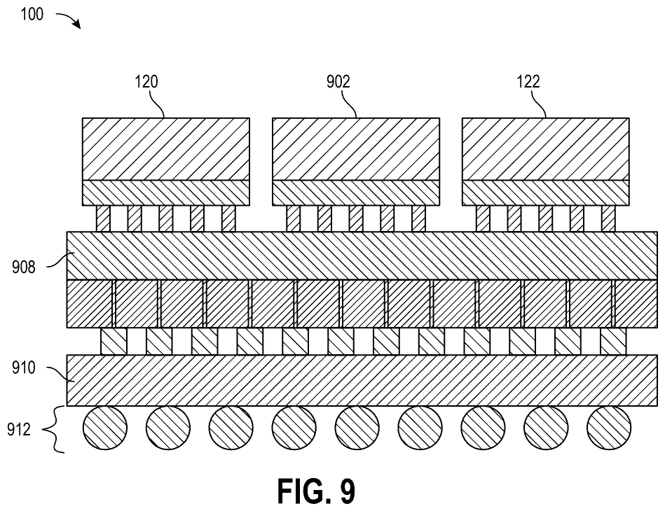

FIG. 9 depicts IC device 100, according to another embodiment. In the example of FIG. 9, IC device 100 includes one or more additional dies, depicted here as a die 902. dies 120, 122, and 902 are interconnected via an interpose 908, which is mounted on a package substrate 910. Package substrate 910 may include external pads 912 and internal interconnects to provide electrical interconnections between dies 120, 122, and 902 and one or more external devices (e.g., via interposer 908 and an external printed circuit board, wiring substrate, and/or interposer). The example of FIG. 9 may be referred to as a 2.5-dimensional (2.5D) IC device 100.

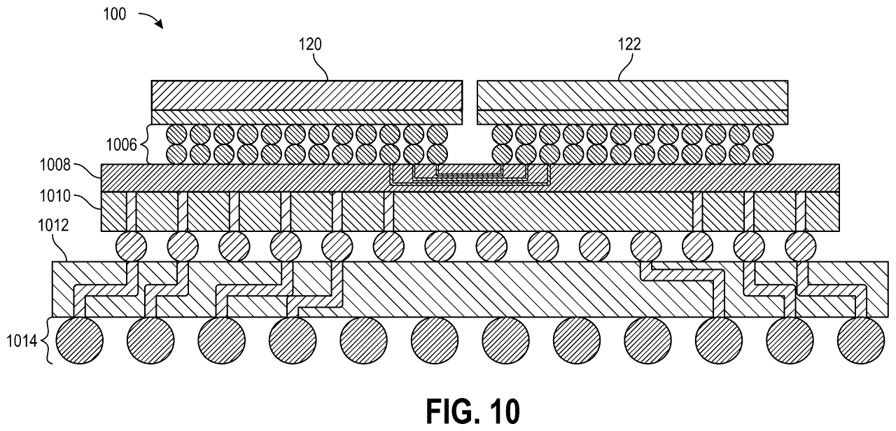

FIG. 10 depicts IC device 100, according to another embodiment. In the example of FIG. 10, die 120 may represent a memory device, which may include a stack of memory dies arranged as a high-bandwidth memory (HBM) device, and die 122 may include a processor, memory, and one or more blocks of circuitry, which may be arranged as a system-on-chip (SoC). In the example of FIG. 10, dies 120 and 122 communicate with one another via external pads 1006 (e.g., micro-bumps and/or hybrid bonds) and a wiring substrate 1008 and/or an interposer 1010, which may be mounted on a package substrate 1012. Package substrate 1012 may include external pads 1014 and internal interconnects to provide electrical interconnections between dies 120 and 122 and one or more external devices (e.g., via wiring substrate 1008, interposer 1010, and an external printed circuit board, wiring substrate, and/or interposer).

Circuit topologies presented herein can be flipped (i.e., reversed or inverted) to take advantage of complimentary MOS process technology. As an example, circuit components depicted in a top-die can be placed in a bottom die in the corresponding complementary circuit implementation, and vice versa.

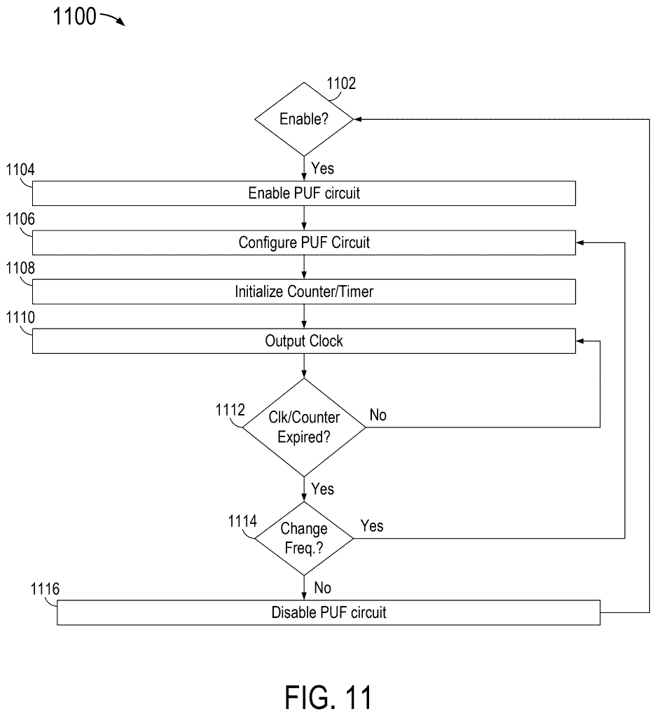

FIG. 11 depicts a method 1100 of generating a clock having a frequency that is based in part on random variations of a PUF circuit, according to an embodiment. Method 1100 is described below with reference to PUF circuit 102, as depicted in FIG. 5, and ring oscillator circuit 112, as depicted in FIG. 7. Method 1100 is not, however, limited to the examples of FIGS. 5 and 7.

At 1102, when PUF circuit 102 is to be operated, processing proceeds to 1104.

At 1104, PUF circuit 102 is enabled. In FIG. 5, control circuitry 130 pulls-down power gate control 132 to provide gated supply voltage 110 to current source circuit 108. In FIG. 7, control circuitry 130 activates isb_trim 151, RO_en control 708, and Out_en control 718. Control circuitry 130 may also activate divider_en control 712.

At 1106, control circuitry 130 configures PUF circuit 102. In FIG. 5, control circuitry 130 may select one of multiple differential amplifier circuits 310-1 through 310-m with OTA_Sel control 504, one or more resistors of resistor circuit 404 with r_trim control 506, and/or one or more of transistors P3-1 through P3-q of ring oscillator current source circuit 202 with isb_trim control 510.

At 1108, a counter or timer is initialized.

At 1110, PUF circuit 102 generates clock 114 having a first frequency that is based on gate delays of ring oscillator circuit 112 and random variations of components (e.g., transistors and resistors) of PUF circuit 102.

At 1112, when the counter or timer reaches a desired count or time (i.e., when the counter/time expires), processing proceeds to 1114.

At 1116, if another frequency is desired (e.g., for time-multiplexing multiple frequencies), processing returns to 1106, where control circuitry 130 configures PUF circuit 102.

When no further frequencies are desired, processing proceeds to 1116, where PUF circuit 102 is disabled. Processing may return to 1102.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An integrated circuit device, comprising:
a physical unclonable function (PUF) circuit distributed over multiple dies of the integrated circuit device, wherein the PUF circuit comprises:
a current source circuit configured to source first, second, and third currents from a gated supply voltage, and to control the first, second, and third currents based on an analog voltage;
a voltage control circuit configured to control the analog voltage based on the first and second currents; and
a ring oscillator circuit configured to output a clock having a frequency that is based on the third current and random variations of components of the PUF circuit.

2. The integrated circuit device of claim 1, wherein:
a first one of the dies comprises the voltage control circuit and the ring oscillator circuit; and
a second one of the dies comprises the current source circuit.

3. The integrated circuit device of claim 2, wherein the first die further comprises a power gate circuit configured to provide the gated supply voltage to the second die.

4. The integrated circuit device of claim 1, wherein the voltage control circuit comprises:
a first load configured to establish a first voltage based on the first current;
a second load configured to establish a second voltage based on the second current; and
a differential amplifier circuit configured to control the analog voltage based on the first and second voltages.

5. The integrated circuit device of claim 4, wherein:
the first load comprises a first resistor circuit in series with a first diode-connected transistor, in parallel with a second resistor circuit; and
the second load comprises a second diode-connected transistor.

6. The integrated circuit device of claim 4, wherein the differential amplifier circuit comprises a differential-input operational transconductance amplifier.

7. The integrated circuit device of claim 1, wherein the current source circuit comprises:
a first transistor configured to source the first current from the gated supply voltage;
a second transistor configured to source the second current from the gated supply voltage; and
a ring oscillator current source circuit that comprises a third transistor configured to source the third current from the gated supply voltage;
wherein gates of the first, second, and third transistors are controlled by the analog voltage.

8. The integrated circuit device of claim 1, wherein:
the PUF circuit is configurable to alter the frequency of the clock; and
the integrated circuit device further comprises control circuitry to configure the PUF circuit.

9. The integrated circuit device of claim 8, wherein the voltage control circuit comprises:
multiple differential oscillator circuits configured to control respective analog voltages based on the first and second currents, wherein the analog voltages differ from one another due to random variations of circuit elements of the differential oscillator circuits; and
selection circuitry configured to provide a selectable one of the analog voltages to the current source circuit based on a control from the control circuit.

10. The integrated circuit device of claim 8, wherein the voltage control circuit comprises:
a first load configured to establish a first voltage based on the first current, wherein the first load comprises a first resistor circuit in series with a first diode-connected transistor, in parallel with a second resistor circuit that comprises a bank of resistors, and selection circuitry configured to select one of more of the resistors of the bank of resistors based on a control from the control circuit;
a second load configured to establish a second voltage based on the second current; and
a differential amplifier circuit configured to control the analog voltage based on the first and second voltages.

11. The integrated circuit device of claim 8, wherein the current source circuit comprises:
a first transistor configured to source the first current from the gated supply voltage;
a second transistor configured to source the second current from the gated supply voltage; and
a ring oscillator current source circuit that comprises multiple transistors and selector circuitry configured to select one or more of the multiple transistors to source the third current from the gated supply voltage based on a control from the control circuitry;
wherein gates of the first transistor, the second transistor, and selected ones of the multiple transistors are controlled by the analog voltage.

12. The integrated circuit device of claim 8, wherein the control circuitry is configured to:
sequentially configure the PUF circuit in each of multiple configurations for respective periods of time to provide the clock with time-multiplexed frequencies.

13. The integrated circuit device of claim 12, further comprising a signature generator circuit configured to:
determine a first bit value based on two or more of the time-multiplexed frequencies;
determine additional bit values based on time-multiplexed frequencies of clocks generated by respective additional PUF circuits of the integrated circuit device; and
construct a signature that is unique to the integrated circuit device based on the first bit value and the additional bit values.

14. The integrated circuit device of claim 12, further comprising a signature generator circuit configured to:
determine multiple bit values based on respective subsets of two or more of the time-multiplexed frequencies; and
construct a signature that is unique to the integrated circuit device based on the multiple bit values.

15. An integrated circuit device, comprising:
a first die comprising a voltage control circuit configured to control an analog voltage based on first and second currents, and further comprising a ring oscillator circuit configured to generate a clock based on a third current;
a second die comprising a current source circuit configured to source the first and second currents and a third current from a gated supply voltage, and to control the first, second, and third currents based on the analog voltage; and
a signature generator circuit configured to determine a bit value based on a frequency of the clock, and to construct a signature of the integrated circuit device based on the bit value.

16. The integrated circuit device of claim 15, wherein:
the integrated circuit device further comprises control circuitry configured to sequentially configure one or more of the voltage control circuit and the current source circuit in each of multiple configurations for respective periods of time to provide the clock with time-multiplexed frequencies; and
the signature generator circuit is further configured to determine the bit value based on two or more of the time-multiplexed frequencies.

17. The integrated circuit device of claim 16, wherein:
the signature generator circuit is further configured to determine multiple bit values based on multiple respective subsets of the time-multiplexed frequencies, and to construct the signature of the integrated circuit device based on the bit values.

18. A method, comprising:
providing a gated supply voltage from a first die of an integrated circuit device to a second die of the integrated circuit device;
sourcing first, second, and third currents from the gated supply voltage and controlling the first, second, and third currents based on an analog voltage, by a current source circuit of the second die;
controlling the analog voltage based on the first and second currents, by a voltage control circuit of the first die; and
generating a clock based on the third current, by a ring oscillator circuit of the first die.

19. The method of claim 18, further comprising:
sequentially configuring one or more of the voltage control circuit and the current source circuit in each of multiple configurations for respective periods of time to provide the clock with time-multiplexed frequencies.

20. The method of claim 19, further comprising:
determining one or more bit values based the time-multiplexed frequencies; and
constructing a signature that is unique to the integrated circuit device based on the one or more bit values.
